(19) United States
(12) Patent Application Publication
(10) Pub. No.: US 2015/0348323 A1
(43) Pub. Date: Dec. 3, 2015

(54) AUGMENTING A DIGITAL IMAGE WITH DISTANCE DATA DERIVED BASED ON ACTUATION OF AT LEAST ONE LASER

(71) Applicant: Lenovo (Singapore) Pte. Ltd., New Tech Park (SG)

(72) Inventor: MARK CHARLES DAVIS, Durham, NC (US)

(73) Assignee: Lenovo (Singapore) Pte. Ltd., New Tech Park (SG)

(21) Appl. No.: 14/293,592

(22) Filed: Jun. 2, 2014

(51) Int. Cl. G06T 19/00; H04N 5/33; H04N 13/02

(52) U.S. Cl. CPC G06T 19/006; H04N 13/0203; H04N 5/33

(57) ABSTRACT

In one aspect, a device includes a digital camera, a three-dimensional (3D) imaging device, a processor, and a memory accessible to the processor. The memory bears instructions executable by the processor to actuate the 3D imaging device to determine distance data pertaining to the distance from the 3D imaging device to at least a portion of at least one object, and actuate the digital camera to gather a first image of a field of view including at least the portion of the at least one object during actuation of the 3D imaging device. The instructions are also executable by the processor to generate an augmented image using the distance data and the first image. The augmented image is generated at least in part based on the portion of the at least one object as gathered by the first image being augmented using the distance data.

### I. FIELD

The present application relates generally to augmenting an image using distance data derived based on actuation of at least one laser.

### II. BACKGROUND

In three-dimensional (3D) imaging, it is often desirable to represent objects in an image as three-dimensional (3D) representations that are as close to their real-life appearance as possible. However, there are currently no adequate, cost effective devices for doing so, much less ones that have ample range and depth resolution capabilities.

### SUMMARY

Accordingly, in one aspect a device includes a digital camera, a three-dimensional (3D) imaging device, a processor, and a memory accessible to the processor. The memory bears instructions executable by the processor to actuate the 3D imaging device to determine distance data pertaining to the distance from the 3D imaging device to at least a portion of at least one object, and actuate the digital camera to gather a first image of a field of view including at least the portion of the at least one object during actuation of the 3D imaging device. The instructions are also executable by the processor to generate an augmented image using the distance data and the first image. The augmented image is generated at least in part based on the portion of the at least one object as gathered by the first image being augmented using the distance data.

In another aspect, a method includes receiving a distance metric from a three-dimensional (3D) infrared (IR) imaging device and applying the distance metric to a digital image gathered by a digital camera to render an augmented image incorporating the distance metric.

In still another aspect, a device includes a digital camera, at least one infrared (IR) laser, a processor, and a memory accessible to the processor. The memory bears instructions executable by the processor to determine the distance from the device to an object in the field of view of the digital camera based at least in part on the time for an IR pulse from the IR laser to be reflected off the object after being emitted from the IR laser, and to alter an image of the object gathered by the digital camera based on the distance.

In yet another aspect, a device includes an image signal processor, where the image signal processor receives a distance metric from a distance determining device and applies the distance metric to a digital image gathered by a digital camera to render an augmented image incorporating the distance metric.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is a block diagram of a network of devices in accordance with present principles;

FIG. 3 is an example illustration of present principles;

FIGS. 4 and 5 are flow charts showing example algorithms in accordance with present principles;

FIGS. 6 and 7 are example user interfaces (UI) in accordance with present principles.

### DETAILED DESCRIPTION

This disclosure relates generally to device-based information. With respect to any computer systems discussed herein, a system may include server and client components, connected over a network such that data may be exchanged between the client and server components. The client components may include one or more computing devices including televisions (e.g. smart TVs, Internet-enabled TVs), computers such as desktops, laptops and tablet computers, so-called convertible devices (e.g. having a tablet configuration and laptop configuration), and other mobile devices including smart phones. These client devices may employ, as non-limiting examples, operating systems from Apple, Google, or Microsoft. A Unix or similar such as Linux operating system may be used. These operating systems can execute one or more browsers such as a browser made by Microsoft or Google or Mozilla or other browser program that can access web applications hosted by the Internet servers over a network such as the Internet, a local intranet, or a virtual private network.

As used herein, instructions refer to computer-implemented steps for processing information in the system. Instructions can be implemented in software, firmware or hardware; hence, illustrative components, blocks, modules, circuits, and steps are set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed, in addition to a general purpose processor, in or by a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Any software and/or applications described by way of flow charts and/or user interfaces herein can include various sub-routines, procedures, etc. It is to be understood that logic divulged as being executed by e.g. a module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium (e.g. that may not be a carrier wave) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and twisted pair wires. Such connections may include wireless communication connections including infrared and radio.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

“A system having one or more of A, B, and C” (likewise “a system having one or more of A, B, or C” and “a system having one or more of A, B, C”) includes systems that have A alone, B alone, C alone, A and B together, A and C together, B and C together, and/or A, B, and C together, etc.

The term “circuit” or “circuitry” is used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

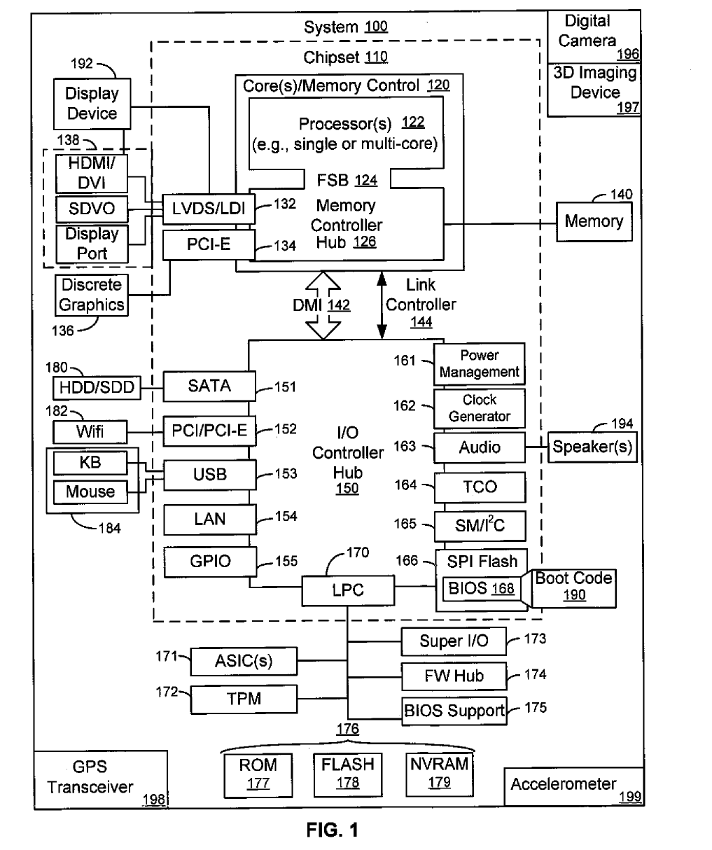

Now specifically in reference to FIG. 1, it shows an example block diagram of an information handling system and/or computer system 100. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100.

As shown in FIG. 1, the system 100 includes a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the conventional “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 further includes a low-voltage differential signaling interface (LVDS) 132. The LVDS 132 may be a so-called LVDS Display Interface (LDI) for support of a display device 192 (e.g., a CRT, a flat panel, a projector, a touch-enabled display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including e.g. one of more GPUs). An example system may include AGP or PCI-E for support of graphics.

The I/O hub controller 150 includes a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 provide for communication with various devices, networks, etc. For example, the SATA interface 151 provides for reading, writing or reading and writing information on one or more drives 180 such as HDDs, SDDs or a combination thereof, but in any case the drives 180 are understood to be e.g. tangible computer readable storage mediums that may not be carrier waves. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

In addition to the foregoing, the system 100 is understood to include a camera 196, which is in communication with and provides input to the processor 122. The camera 196 may be, e.g., a thermal imaging camera, a digital camera such as a webcam, a camera configured for gathering infrared (IR) light (e.g. a specialized IR camera, a camera with IR response, etc.), and/or another suitable camera integrated into the system 100 and controllable by the processor 122 to gather images and/or video.

A three-dimensional imaging device 197 is also shown. The device 197 is understood to be configured to determine distance data pertaining to the distance from the system 100 and/or device 197 to one or more objects based on e.g. light emitted from lasers thereon (e.g. vertical cavity surface emitting lasers) such as e.g. light visible to the human eye and/or infrared (IR) light.

In addition to the foregoing, FIG. 1 shows a GPS transceiver 198 is shown that is configured to e.g. receive geographic position information from at least one satellite and provide the information to the processor 122. However, it is to be understood that another suitable position receiver other than a GPS receiver may be used in accordance with present principles to e.g. determine the location of the system 100. In any case, an accelerometer 199 is also shown for e.g. sensing acceleration and/or movement of the system 100.

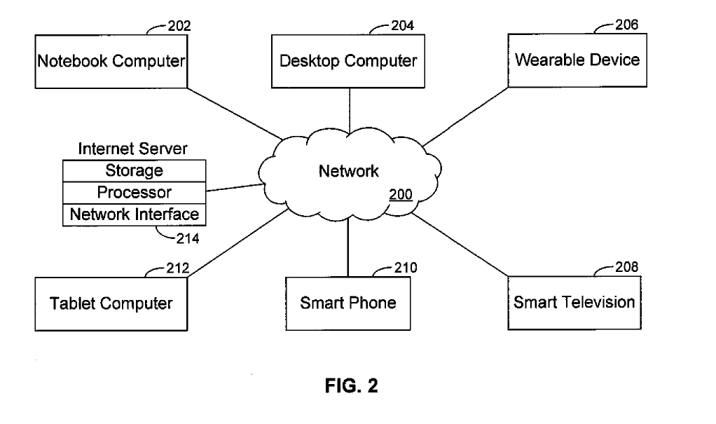

Before moving on to FIG. 2, it is to be understood that an example client device or other machine/computer may include fewer or more features than shown on the system 100 of FIG. 1. In any case, it is to be understood at least based on the foregoing that the system 100 is configured to undertake present principles.

Turning now to FIG. 2, it shows example devices communicating over a network 200 such as e.g. the Internet in accordance with present principles. It is to be understood that e.g. each of the devices described in reference to FIG. 2 may include at least some of the features, components, and/or elements of the system 100 described above. In any case, FIG. 2 shows a notebook computer 202, a desktop computer 204, a wearable device 206 such as e.g. a smart watch, a smart television (TV) 208, a smart phone 210, a tablet computer 212, and a server 214 in accordance with present principles such as e.g. an Internet server that may e.g. provide cloud storage accessible to the devices 202-212. It is to be understood that the devices 202-214 are configured to communicate with each other over the network 200 to undertake present principles.

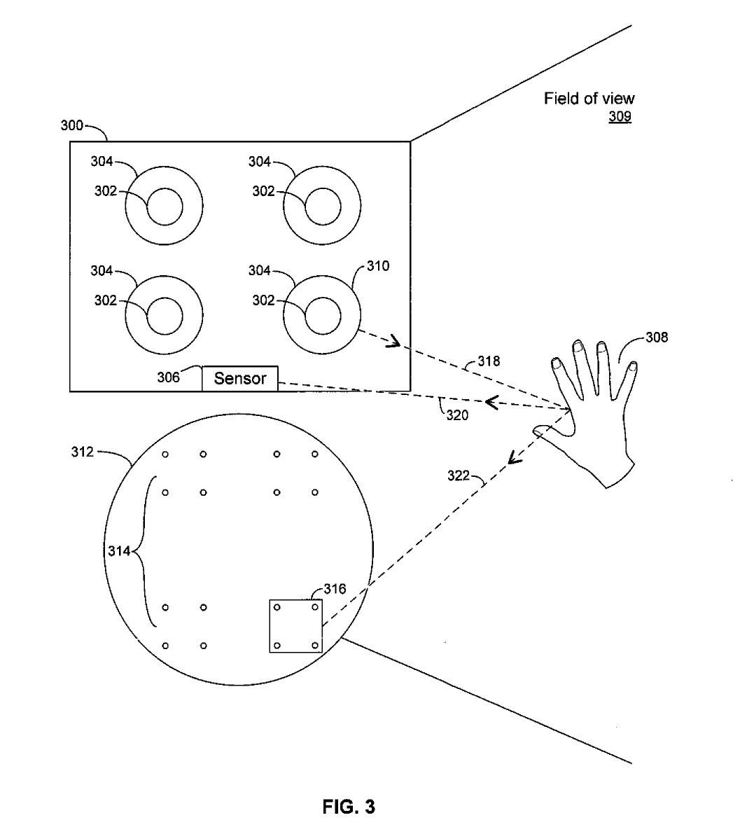

Now describing FIG. 3, it is an illustration showing an example 3D imaging device 300 including plural lasers 302 respectively configured to emit light such as e.g. infrared laser pulses through a respective lens 304 for each laser 302. Thus, it is to be understood that in example embodiments, each of the lasers 302 may be arranged to emit laser pulses for each laser 302 through a respective lens 304 at an angle different than the other lasers 302 on the device 300 based on e.g. the orientation and/or the angle of arrangement of the lens 304. In addition to the foregoing, also note that the device 300 includes at least one sensor 306 for sensing light reflected from and/or off an object 308 in a field of view 309 of the device 300 and/or a camera 312, such as a hand of a person, from a first laser and lens combination 310. Although only one sensor 306 is shown, it is to be understood that in some embodiments each laser 302/lens 304 combination may have its own respective sensor associated therewith for sensing light reflected off an object in accordance with present principles.

In any case, FIG. 3 also shows a camera 312 such as e.g. a digital camera. The camera 312 is understood to include plural pixels 314 for gathering light to generate an image in accordance with present principles. Thus, e.g. note that a first set 316 of pixels 314 are pixels for which light from the first laser/lens combination 310 is gathered based on e.g. the angle of reflection of light from the first laser/lens combination 310 off the object 308.

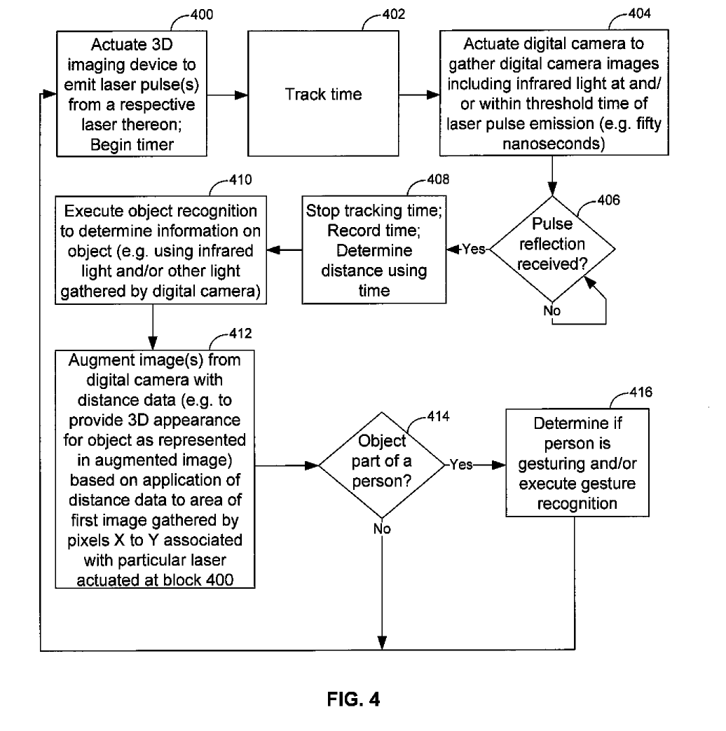

Accordingly, note that example line 318 represents the path of e.g. an IR laser pulse from the first laser/lens combination 310 at a particular angle to the object 308. Also note that example line 320 represents the path of the IR light from the IR pulse as e.g. disbursed and/or reflected off the object 308 back to the sensor 306 to thus determine the distance from the device 300 to the object 308 based on the time taken for light from the first laser/lens combination 310 to travel the path represented by line 318, be reflected off the object 308, and travel the path represented by line 320. This distance may be determined based on an equation such as e.g. distance=(speed of light×time)/2. Before moving on to FIG. 4, also note that an example line 322 is shown, and is understood to represent the path of e.g. the IR light emitted by the first laser/lens combination 310 as e.g. disbursed and/or reflected off the object 308 to and/or as gathered by the first set 316 of pixels. Also before moving on to FIG. 4, note that both the device 300 and camera 312 may be arranged on a single device, such as e.g. the system 100 described above.

Referring now to FIG. 4, it shows example logic that may be undertaken by a device such as the system 100 in accordance with present principles (referred to below as the “present device”). Beginning at block 400, the logic actuates a 3D imaging device to emit one or more laser pulses respectively from one or more lasers of the 3D imaging device. Also at block 400, the logic initiates a timer to determine the length of time taken for at least some of the light from the pulse(s) to be reflected back to the 3D imaging device from an object. Thus, the logic tracks the length of time at block 402, and then at block 404 actuates (e.g. simultaneously during actuation of the 3D imaging device or immediately following it) a digital camera on the present device to gather one or more digital images per a field of view of the camera, which in some embodiments may be e.g. images with 3D representations of objects in the images, the appearance of which may be improved, altered, and/or augmented using distance data as set forth herein.

Regardless, note that at least one of the digital images may include e.g. light from pulses emitted at block 400, and/or at least a portion of at least one object in the field of view. Furthermore, it is to be understood that the camera is actuated at block 404 at the time the laser pulse is reflected back to the present device and/or within a threshold time (e.g. fifty nanoseconds) before and/or after the laser pulse being emitted.

Further still, it is to be understood that in example embodiments, multiple images may be gathered by the digital camera after emission of the laser pulse, where those images may then be processed by the present device to determine which if any of them include light from the laser pulse (e.g., infrared (IR) light). The present device may then determine that the image including the light from the laser pulse is to be used to produce an augmented image in accordance with present principles.

In any case, from block 404 the logic proceeds to decision diamond 406, at which the logic determines whether a laser pulse reflection has reached the present device (e.g. reached a sensor of the 3D imaging device such as the sensor 306 described above). A negative determination causes the logic to continue making the determination at diamond 406 until an affirmative determination is made. Then, responsive to an affirmative determination at diamond 406, the logic proceeds to block 408. At block 408 (e.g. at least substantially in real time with the affirmative determination at diamond 406), the logic stops the timer and/or stops tracking time. The length of time indicated by the timer, which has been stopped, and which is understood to correspond to the time taken for the laser pulse emitted at block 400 to be reflected back to the present device, may then be saved and/or recorded (e.g. locally at the present device). The distance to the object which reflected the laser pulse may then be determined, also at block 408.

The logic may compute the distance by taking the speed of light (e.g. at the present location of the present device accounting for e.g. atmospheric variables) and multiplying it by the length of time from the timer. That number may then be divided by two to determine the distance.

From block 408 the logic proceeds to block 410. At block 410 the logic executes object recognition on at least one object in at least one of the images gathered at block 404, including e.g. an image of reflected IR light from the laser pulse light hitting an object. Object recognition is executed to determine information regarding the object, including e.g. identification of the object as being a single unitary object and/or identification of the object itself (e.g. a hand of a person, a lamp, a television, etc.), and/or identification of the boundaries of the object relative to other portions of the image. Once the object which reflected the laser pulse has been identified based on object recognition of the portion of the image including the IR light, the logic may proceed to block 412. However, before describing block 412, it is to be understood that the object recognition at block 410 may, in addition to or in lieu of the foregoing, be executed e.g. using digital images from the camera other than the one or more images that include the IR light to thus e.g. further identify the object.

In any case, at block 412 the logic augments at least one image from the digital camera gathered at block 404 (e.g. the image including the IR light reflection, and/or another image taken substantially at the same time (e.g. within a few hundred nanoseconds) for which the same object that reflected the IR pulse is identified as being located therein) with distance data (e.g. the distance determined at block 408) to render a 3D appearance of the object as appearing in an augmented image derived from the e.g. “original” image prior to augmentation.

In non-limiting embodiments, the image may be augmented by e.g. applying the distance data to an area of the image at which the (e.g. unitary and/or identified) object is shown as determined at block 410 and that was gathered by camera pixels of the digital camera associated with the particular laser that emitted the pulse at block 400 from which the distance data was determined, and then adjusting the appearance of the object as represented in the image to correspond (e.g. three-dimensionally) to the distance applied to it, while still e.g. maintaining the same if not a better resolution for the augmented image relative to the image gathered at block 404. The association of camera pixels with lasers will be described further below.

From block 412 the logic proceeds to decision diamond 414. At diamond 414, the logic determines whether the object recognized based on the object recognition executed at block 410 is a portion of a body of a user. A negative determination causes the logic to revert back to block 400 and proceed therefrom by actuating another laser of the 3D imaging device to thus, e.g. actuate plural lasers in sequence (e.g. every twenty to fifty nanoseconds) and/or randomly to determine distance data for other portions of the object and/or other objects in the field of view (e.g. emit laser pulses in sequence to respectively determine distance data for different portions of one or more objects in the field of view based on the “time of flight” of reflection of pulses emitted from different ones of the respective lasers). In any case, an affirmative determination at diamond 414 instead causes the logic to proceed to block 416. At block 416 the logic determines if the portion of the user is gesturing, and/or may execute gesture recognition for the portion of the user using the images gathered at block 404 and/or using additional images from the digital camera which may be gathered at block 416 upon determining the portion of the person is gesturing.

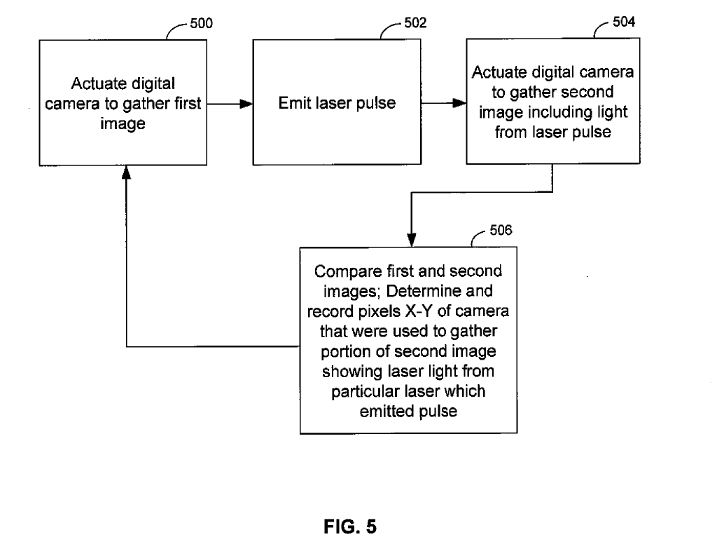

Reference is now made to FIG. 5, which shows example logic that may be executed by a device such as the system 100 in accordance with present principles. It is to be understood that the logic of FIG. 5 may be executed during e.g. a calibration of a 3D imaging device and digital camera combination of a system (e.g., the system 100) to thus associate IR light emitted by different lasers of a 3D imaging device of the system at different angles with different respective pixels and/or sets of pixels of the digital camera e.g. based on a particular (e.g. current) field of view. Thus, it is to be understood that in some embodiments the field of view may be e.g. white space occupying the entirety of the field of view of the digital camera, and in other embodiments may be e.g. the specific field of view for which an augmented image is to be generated in accordance with present principles.

In any case, the logic begins at block 500 where the logic actuates the digital camera to gather a first image of the field of view. Then at block 502 the logic emits a laser pulse from a first laser in accordance with present principles. Further, at block 504, the logic actuates the digital camera to gather a second image of the field of view that includes light emitted at block 502. Then, at block 506, the logic compares the first and second images and determines which pixels of the digital camera gathered light from the laser emitted at block 502 based on e.g. differences in the images. The logic at block 506 may also store information pertaining to the pixels that were identified as gathering the light from the first laser. From block 506 the logic may revert back to block 500 and proceed therefrom, but undertaking the logic for a second laser on the 3D imaging device to thus determine e.g. other, different pixels to associate with the second laser in accordance with present principles.

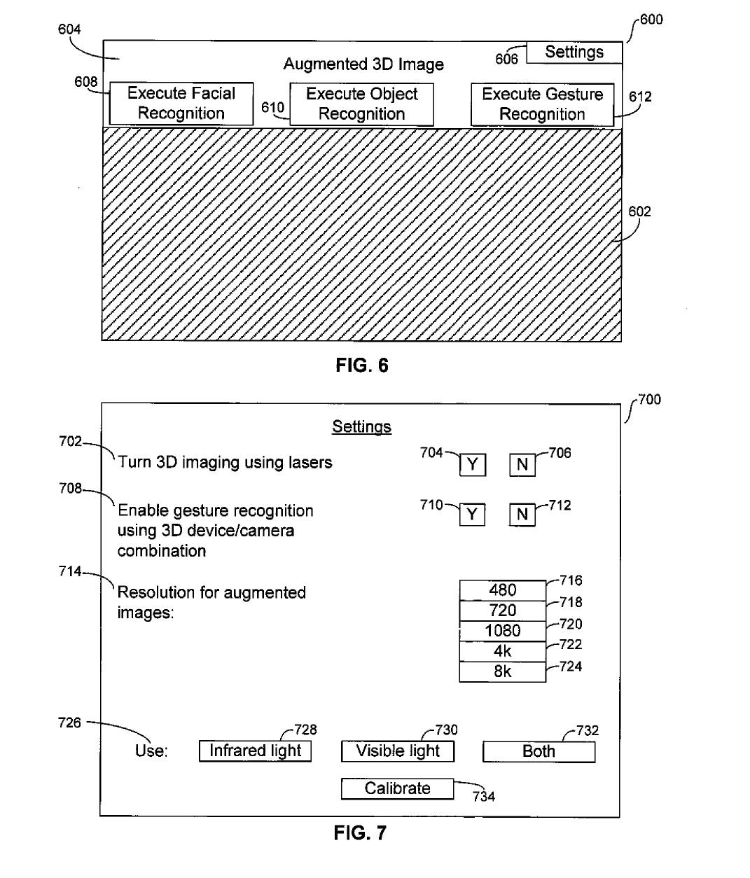

Continuing the detailed description in reference to FIG. 6, it shows an example UI 600 presented on a device such as the system 100. The UI 600 includes an augmented image in accordance with present principles understood to be represented on the area 602, and also an upper portion 604 including plural selector elements for selection by a user. Thus, a settings selector element 606 is shown on the portion 604, which may be selectable to automatically without further user input responsive thereto cause a settings UI to be presented on the device for configuring settings of the camera and/or 3D imaging device, such as the settings UI 700 to be described below.

Another selector element 608 is shown for e.g. automatically without further user input causing the device to execute facial recognition on the augmented image to determine the faces of one or more people in the augmented image. Furthermore, a selector element 610 is shown for e.g. automatically without further user input causing the device to execute object recognition on the augmented image 602 to determine the identity of one or more objects in the augmented image. Still another selector element 612 for e.g. automatically without further user input causing the device to execute gesture recognition on one or more people and/or objects represented in the augmented image 602 and e.g. images taken immediately before and after the augmented image.

Now in reference to FIG. 7, it shows an example settings UI 700 for configuring settings of a system in accordance with present principles. The UI 700 includes a first setting 702 for configuring the device to undertake 3D imaging as set forth herein, which may be so configured automatically without further user input responsive to selection of the yes selector element 704 shown. Note, however, that selection of the no selector element 706 automatically without further user input configures the device to not undertake 3D imaging as set forth herein.

A second setting 708 is shown for enabling gesture recognition using e.g. laser pulses and images from a digital camera as set forth herein, which may be enabled automatically without further user input responsive to selection of the yes selector element 710 or disabled automatically without further user input responsive to selection of the no selector element 712. Note that similar settings may be presented on the UI 700 for e.g. object and facial recognition as well, mutatis mutandis, though not shown in FIG. 7.

Still another setting 714 is shown. The setting 714 is for configuring the device to render augmented images in accordance with present principles at a user-defined resolution level. Thus, each of the selector elements 716-724 are selectable to automatically without further user input responsive thereto to configure the device to render augmented images in the resolution indicated on the selected one of the selector elements 716-724, such as e.g. four hundred eighty, seven hundred twenty, so-called “ten-eighty,” four thousand, and eight thousand.

Still in reference to FIG. 7, still another setting 726 is shown for configuring the device to emit laser pulses in accordance with present principles in e.g. infrared light (e.g. automatically without further user input based on selection of the selector element 728), in light visible to the human eye (e.g. automatically without further user input based on selection of the selector element 730), or in both IR light and light visible to the human eye (e.g. automatically without further user input based on selection of the selector element 732). Last, note that a selector element 734 is shown for automatically without further user calibrating the system in accordance with present principles, such as is set forth above in reference to the logic of FIG. 5.

Without reference to any particular figure, it is to be understood by actuating lasers such as e.g. vertical cavity surface emitting lasers that emit e.g. low power infrared pulses or other invisible light and determine a distance in accordance with present principles, and also by actuating a digital camera to “see” what the pulses emitted by the lasers are hitting, an augmented image may be generated that has a relatively high resolution owing to use of the digital camera image but also having relatively more accurate and realistic 3D representations as well.

Furthermore, this image data may facilitate better object and gesture recognition. Thus, e.g. a device in accordance with present principles may determine that an object in the field of view of a 3D laser rangerfinder device is a user's hand at least in part owing to the range determined from the device to the hand, and at least in part owing to use a digital camera to undertake object and/or gesture recognition to determine e.g. a gesture in free space being made by the user.

Additionally, it is to be understood that in some embodiments an augmented image need not necessarily be a 3D image per se but in any case may be e.g. an image having distance data applied thereto as metadata to thus render the augmented image, where the augmented image may be interactive when presented on a display of a device so that a user may select a portion thereof (e.g. an object shown in the image) to configure a device presenting the augmented image (e.g. using object recognition) to automatically provide an indication to the user (e.g. on the display and/or audibly) of the actual distance from the perspective of the image (e.g. from the location where the image was taken) to the selected portion (e.g. the selected object shown in the image). What's more, it may be appreciated based on the foregoing that an indication of the distance between two objects in the augmented image may be automatically provided to a user based on a user selecting a first of the two objects and then selecting a second of the two objects (e.g. by touching respective portions of the augmented image as presented on the display that show the first and second objects).

It may now be appreciated that present principles provide for a (e.g. single) laser chip that provides electronically steered laser emissions from one or more lasers, data from which is then used in combination with data from a high-resolution camera such as e.g. a digital camera to provide an augmented 3D image. In one example, each of the lasers fires, and a time of flight is recorded. The range data for each laser may then combined with the image taken at the same time. By analyzing the area of the image corresponding to a laser, a range may be assigned to a particular point in the image.

Providing more specificity, a laser system may provide range data for each laser. The laser array may be, e.g., twenty by twenty. From the calibration discussed herein, the system knows that laser X corresponds to pixels N to M on the high resolution camera. The high resolution camera may thus “see” the laser light (e.g. infra-red), and do object recognition using that light. If for some reason the high resolution camera cannot “see” the IR light, it may be used to do object recognition using available (e.g. visible) light. But in any case, the device uses object recognition techniques and/or applications to tie the range data from laser X to the best pixel or most applicable pixels (e.g. based on the ones that collected IR light regarding the object) in the range N to M. If a “total” 3D image is desired (e.g. where it is desirable to assign a range to each of the millions of pixels of a high resolution camera that generated the image), a “far” range may be assigned to any pixels not part of the recognized object in the range N to M. This far range may be infinity, or may be a relatively nearby but still longer range, or may be the longest range found in field of view of the device. In any case, when e.g. the array is twenty by twenty, range data may be available for anywhere from e.g. one to four hundred objects in the field of view.

Providing another example, a time of travel ranging device may be used (e.g., laser or non-laser, and/or sonic) to get a range, then object recognition may be done on an image from a digital camera to determine what object the range pertains to. Thus, a one-dimensional input and a two-dimensional input may be taken to make a three-dimension output. Furthermore, when using a directional ranging method (e.g. such as pointing a laser at different directions), that may facilitate the process of the above owing to less area having to be processed, and accordingly also rendering a relatively higher likelihood of selecting the correct object corresponding to the range in addition to having a relatively better 3D picture owing to relatively more range/object pairs. The output may be a 3D image (by e.g. approximating and/or estimating ranges not supplied by a ranging device), and/or it may be a set of object definitions including recognized objects and locations (e.g. bearing, elevation, range). Further still, image signal processors (ISPs) may be used in accordance with present principles.

Providing an example of calibration of the system as disclosed herein, it may be done by turning on one laser, then examining the image to correlate the camera pixels with the laser emission cone. A field of view of a white background may be used, or any other background may be used. In any case, more specifically and following up on the example above, e.g. a picture may be taken, then laser X may be turned on, then another picture may be taken. The system may then record pixels N to M that show laser illumination, and thus associate them with laser X.

Still without reference to any particular figure, it is to be understood that analysis of edge detection and other two-dimensional recognition techniques may also be used in accordance with present principles to thus provide even better resolution of an image for the range that is determined. E.g., the device may examine the part of the frame illuminated by laser X and reduce the pixels from N to M to just those pixels in the range N to M of the object.

Before concluding, it is to be understood that although e.g. a software application for undertaking present principles may be vended with a device such as the system 100, present principles apply in instances where such an application is e.g. downloaded from a server to a device over a network such as the Internet. Furthermore, present principles apply in instances where e.g. such an application is included on a computer readable storage medium that is being vended and/or provided, where the computer readable storage medium is not a carrier wave or a signal per se.

While the particular AUGMENTING A DIGITAL IMAGE WITH DISTANCE DATA DERIVED BASED ON ACTUATION OF AT LEAST ONE LASER is herein shown and described in detail, it is to be understood that the subject matter which is encompassed by the present application is limited only by the claims.

What is claimed is:

1. A device, comprising:
a digital camera;
a three-dimensional (3D) imaging device;
a processor; and
a memory accessible to the processor and bearing instructions executable by the processor to:
actuate the 3D imaging device to determine distance data pertaining to the distance from the 3D imaging device to at least a portion of at least one object;
actuate the digital camera to gather a first image of a field of view including at least the portion of the at least one object;
generate an augmented image using the distance data and the first image, wherein the augmented image is generated at least in part based on the portion of the at least one object as gathered by the first image being augmented using the distance data.

2. The device of claim 1, wherein the augmented image is a 3D image having at least the same if not a higher amount of resolution than the first image.

3. The device of claim 1, wherein the first image includes a 3D representation of the portion of the at least one object, and wherein the distance data is combined with a portion of the first image including the 3D representation to alter the 3D appearance of the 3D representation as represented in the augmented image.

4. The device of claim 1, wherein the 3D imaging device is a laser-emitting device.

5. The device of claim 4, wherein the 3D imaging device is actuated to emit a laser pulse and determine the distance data at least in part based on the length of time for the laser pulse to be reflected back to the 3D imaging device after emission.

6. The device of claim 5, wherein the 3D imaging device includes a portion with plural lasers arranged thereon and which emit laser pulses at least in part in sequence to respectively determine distance data for different portions of at least one object in the field of view.

7. The device of claim 6, wherein the plural lasers are arranged to emit laser pulses at different angles through respective lenses for each laser.

8. The device of claim 1, wherein the first image is gathered at the same time as actuation of the 3D imaging device.

9. The device of claim 1, wherein the first image is gathered within a threshold time from initial actuation of the 3D imaging device.

10. The device of claim 9, wherein the threshold time is one of: fifty nanoseconds, less than fifty nanoseconds.

11. The device of claim 5, wherein the 3D imaging device is actuated to emit the laser pulse in the infrared (IR) light spectrum.

12. The device of claim 11, wherein the first image gathered by the digital camera includes IR light emitted from the 3D imaging device.

13. The device of claim 12, wherein the device executes object recognition on at least the portion of the at least one object based at least in part on IR light gathered by the digital camera to determine the portion of the at least one object to be augmented using the distance data.

14. The device of claim 7, wherein the instructions are executable by the processor to generate the augmented image at least in part based on:
association by the device of plural pixels of the digital camera with a respective one of the lasers for which light emitted at a particular angle from the respective one of the plural lasers is reflected to the plural pixels; and
application of the distance data determined based on actuation of at least a first respective one of the lasers to a first portion of the first image gathered by a first set of plural pixels of the digital camera to augment the appearance of the first portion, the first set of plural pixels associated by the device with the first respective one of the lasers.

15. A method, comprising:
receiving a distance metric from a three-dimensional (3D) infrared (IR) imaging device;
applying the distance metric to a digital image gathered by a digital camera to render an augmented image incorporating the distance metric.

16. The method of claim 15, wherein the distance metric is determined based at least in part on the time for an IR pulse emitted by the 3D IR device to be reflected off at least a portion of at least one object back to the 3D IR imaging device.

17. The method of claim 16, wherein the digital image includes IR light emitted by the IR imaging device.

18. The method of claim 15, wherein the distance metric pertains to the distance to an object represented in the digital image, wherein the method includes:
performing object recognition on the object to determine to apply the distance metric to the object and not to other portions of the digital image.

19. A device, comprising:
a digital camera;
at least one infrared (IR) laser;
a processor; and
a memory accessible to the processor and bearing instructions executable by the processor to:
determine the distance from the device to an object in the field of view of the digital camera based at least in part on the time for an IR pulse from the IR laser to be reflected off the object after being emitted from the IR laser; and
alter an image of the object gathered by the digital camera based on the distance.

20. The device of claim 19, wherein the image is altered to represent the object in three-dimensional appearance based at least in part on the distance.

21. A device, comprising:
an image signal processor which:
receives a distance metric from a distance determining device;
applies the distance metric to a digital image gathered by a digital camera to render an augmented image incorporating the distance metric.
